(19) United States
(12) Patent Application Publication
(10) Pub. No.: US 2025/0243306 A1
(43) Pub. Date: Jul. 31, 2025

(54) COPOLYMER

(71) Applicant: BOREALIS AG, Vienna (AT)

(72) Inventors: Jingbo WANG, Linz (AT); Friedrich BERGER, Linz (AT); Jani AHO, Porvoo (FI); Juulia HIRVONEN, Kulloo (FI)

(21) Appl. No.: 18/855,025

(22) PCT Filed: Apr. 6, 2023
(86) PCT No.: PCT/EP2023/059162

§ 371 Date: Oct. 8, 2024

(30) Foreign Application Priority Data
Apr. 11, 2022 (EP) 22167661.2

(51) Int. Cl. C08F 210/16; C08J 5/18; C08L 23/0807

(52) U.S. Cl. CPC C08F 210/16; C08J 5/18; C08L 23/0815; C08F 2800/20; C08J 2323/08; C08L 2203/162; C08L 2205/025; C08L 2207/066

(57) ABSTRACT

The invention provides a metallocene-catalysed multimodal ethylene-1-butene random copolymer, having a density in the range of from 910 to 930 kg/m3, an MFR₂ determined according to ISO 1133 at 190° C. and 2.16 kg in the range of from 0.1 to 3.0 g/10 min, a 1-butene content in the range of 1.0 to 20 wt %, an isolated 1-butene comonomer unit amount (EBE %) of greater than 97.0%, whereby the isolated 1-butene comonomer unit amount is calculated according to formula (I), wherein EBE represents amount of comonomer sequence of ethylene, 1-butene and ethylene per 1000 carbon (kCb), EBB represents amount of comonomer sequence of ethylene, 1-butene and 1-butene per 1000 carbon (kCb) and BBB represents amount of comonomer sequence of three consecutive 1-butenes per 1000 carbon (kCb) as described under “Determination methods”; and a ratio of the MFR₂₁ determined according to ISO 1133 at 190° C. and 21.6 kg to MFR₂ determined according to ISO 1133 at 190° C. and 2.16 kg, MFR₂₁/MFR₂, in the range of 22 to 100.

$$EBE \% = 100 \times \frac{E B E}{E B E + E B B + B B B} \qquad ( I )$$

This invention relates to a metallocene-catalysed multimodal polyethylene copolymer and a process of preparing such a copolymer. In particular, the invention relates to a metallocene-catalysed multimodal ethylene-1-butene copolymer with particular properties which render it attractive for use in film applications. The invention further relates to polymer compositions comprising said copolymer as well as films and associated articles prepared from such copolymers.

### BACKGROUND OF INVENTION

Polymer films are widely used in packaging. These films must obviously protect the contents of the package from damage and the environment.

Polyethylene films, particularly those prepared from linear low density polyethylene (LLDPE) are widely used in packaging due to their excellent cost/performance ratios.

Unimodal polyethylene (PE) polymers, for instance SSC products, are usually used for film applications. Unimodal PE polymers have for instance good optical properties, like low haze, but for instance, the melt processing of such polymers is not satisfactory from a production point of view and may cause quality problems of the final product as well. Multimodal PE polymers with two or more different polymer components are better to process, but e.g. melt homogenisation of the multimodal PE may be problematic resulting in inhomogeneous final products evidenced e.g. by high gel content of the final product.

There is a continuous need to find multimodal PE polymers with different property balances for providing tailored solutions to meet the increasing demands of the end application producers e.g. for reducing the production costs while maintaining or even improving the end-product properties. Tailored polymer solutions are also needed to meet the requirements of continuously developing equipment technology in the end application field.

One of the most widely used comonomers in multimodal PE polymers is 1-butene. However, despite being readily available, 1-butene carries with it the disadvantages that the resulting polymers do not possess all the desired properties for film applications, in particular a good balance between mechanical, optical and sealing properties.

Therefore, there is a need in the art for providing an ethylene-1-butene material that provides low sealing initiation temperature, good optical properties and mechanical properties, especially dart drop (impact strength). In other words, a material is desirable that provides an advantageous combination of preferable sealing properties, good optics and mechanical properties, especially SIT, haze and dart drop, to films prepared from such a material. There is thus a desire to develop new ethylene-1-butene copolymers, which offer an improved balance of properties.

WO 2021/013552 discloses a polyethylene composition comprising a base resin, wherein the base resin comprises a first and second ethylene-1-butene fraction. The exemplified compositions have a ratio of the MFR₂₁ (190° C., 21.6 kg, ISO 1133) to MFR₂ (190° C., 2.16 kg, ISO 1133), MFR₂₁/MFR₂ of 20.

The present inventors have unexpectedly found that a particular class of metallocene-catalysed multimodal ethylene-1-butene random copolymers possess an attractive balance of mechanical, optical and sealing properties when employed in film applications.

### SUMMARY OF INVENTION

Viewed from one aspect the invention provides a metallocene-catalysed multimodal ethylene-1-butene random copolymer, having a density in the range of from 910 to 930 kg/m³ determined according to ISO 1183, an MFR₂ determined according to ISO 1133 at 190° C. and 2.16 kg in the range of from 0.1 to 3.0 g/10 min, a 1-butene content in the range of 1.0 to 20 wt %,
an isolated 1-butene comonomer unit amount (EBE %) of greater than 97%, whereby the isolated 1-butene comonomer unit amount is calculated according to formula (I)

$$EBE \% = 100 \times \frac{E B E}{E B E + E B B + B B B}$$

wherein EBE represents amount of comonomer sequence of ethylene, 1-butene and ethylene per 1000 carbon (kCb), EBB represents amount of comonomer sequence of ethylene, 1-butene and 1-butene per 1000 carbon (kCb) and BBB represents amount of comonomer sequence of three consecutive 1-butenes per 1000 carbon (kCb) as described under “Determination methods”; and
   a ratio of the MFR₂₁ determined according to ISO 1133 at 190° C. and 21.6 kg to MFR₂ determined according to ISO 1133 at 190° C. and 2.16 kg, MFR₂₁/MFR₂, in the range of 22 to 100.

Viewed from another aspect, the invention provides a process for preparing a metallocene-catalysed multimodal ethylene-1-butene random copolymer as hereinbefore defined, said process comprising:
(i) polymerising ethylene together with 1-butene, in a first polymerisation stage in the presence of a metallocene catalyst to prepare a first ethylene polymer;
(ii) polymerising ethylene together with 1-butene, in a second polymerisation stage in the presence of said catalyst and said first ethylene polymer to prepare an ethylene polymer mixture comprising said first ethylene polymer and a second ethylene polymer; and
(iii) polymerising ethylene together with 1-butene, in a third polymerisation stage in the presence of said catalyst and said ethylene polymer mixture to prepare said multimodal ethylene-1-butene random copolymer.

Viewed from a further aspect, the invention provides a composition comprising a metallocene-catalysed multimodal ethylene-1-butene random copolymer as hereinbefore defined and 5 to 30 wt % of a low density polyethylene (LDPE), relative to the total weight of the composition.

Viewed from yet another aspect, the invention provides a film comprising a metallocene-catalysed multimodal ethylene-1-butene random copolymer as hereinbefore defined, or a composition as hereinbefore defined.

Viewed from a further aspect, the invention provides an article, preferably a packaging article, comprising a film as hereinbefore defined.

### DETAILED DESCRIPTION

### Definitions

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

The metallocene catalysed multimodal ethylene-1-butene random copolymer is defined in this invention as a multimodal ethylene-1-butene random copolymer which has been produced in the presence of a metallocene catalyst.

The term “random copolymer” in the context of the invention will be understood to be an ethylene copolymer in which the comonomer units (1-butene in the case of this invention) are distributed randomly within the copolymer.

Term “multimodal” means herein multimodality with respect to melt flow rate (MFR) of the ethylene polymer components as well as the preferable ethylene polymer fractions (A-1) and (A-2), i.e. the ethylene polymer components and/or fractions (A-1) and (A-2) have different MFR values. The multimodal ethylene-1-butene random copolymer can have further multimodality with respect to one or more further properties between the ethylene polymer components as well as between fractions (A-1) and (A-2), as will be described later below.

The multimodal ethylene-1-butene random copolymer of the invention as defined above, below or in claims is also referred herein shortly as “multimodal polyethylene”, “multimodal PE” or “multimodal copolymer”. Further, it may simply be referred to as the “polyethylene” of the invention.

The following preferable embodiments, properties and subgroups of multimodal PE and the ethylene polymer components (A) and (B) thereof, as well as the preferable ethylene polymer fractions (A-1) and (A-2) and the film of the invention including the preferable ranges thereof, are independently generalisable so that they can be used in any order or combination to further define the preferable embodiments of the multimodal PE and the article of the invention.

### Metallocene-Catalysed Multimodal Ethylene-1-butene Random Copolymer

It has been found that the multimodal ethylene-1-butene random copolymer according to the invention provides an improved material for film applications, which combines very good sealing properties and mechanical properties e.g. in terms of dart drop strength (DDI), with excellent optical properties e.g. in terms of haze.

The polymer of the invention is a multimodal ethylene-1-butene random copolymer, which can also be termed an ethylene copolymer. By ethylene copolymer is meant a polymer the majority by weight of which derives from ethylene monomer units (i.e. at least 50 wt % ethylene relative to the total weight of the copolymer). It will be appreciated that the ethylene-1-butene copolymer of the invention contains only ethylene and 1-butene monomer units.

The 1-butene content of the copolymer is in the range of 1.0 to 20 wt %, relative to the total weight of copolymer as a whole. The comonomer (1-butene) contribution preferably is 5.0 to 15 wt %, more preferably 8.0 to 10 wt %, relative to the total weight of the copolymer as a whole.

The polymer of the invention is multimodal and therefore comprises at least two components. The polymer is preferably bimodal. The polymer of the invention most preferably comprises
(A) a lower molecular weight ethylene-1-butene copolymer component, and
(B) a higher molecular weight ethylene-1-butene copolymer component.

The polyethylene of the invention is multimodal. Usually, a polyethylene composition comprising at least two polyethylene components, which have been produced under different polymerisation conditions resulting in different (weight average) molecular weights and molecular weight distributions for the components, is referred to as “multimodal”. Accordingly, in this sense the compositions of the invention are multimodal polyethylenes. The prefix “multi” relates to the number of different polymer components the composition is consisting of. The polyethylene may also be multimodal with respect to comonomer content.

The form of the molecular weight distribution curve, i.e. the appearance of the graph of the polymer weight fraction as a function of its molecular weight, of such a multimodal polyethylene will show two or more maxima or at least be distinctly broadened in comparison with the curves for the individual fractions.

For example, if a polymer is produced in a sequential multistage process, utilising reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

The copolymer of the invention has an MFR₂ of 0.1 to 3.0 g/10 min. Preferable ranges for MFR₂ are 0.5 to 2.0 g/10 min, such as 0.8 to 1.5 g/10 min.

The copolymer of the invention preferably has an MFR₂₁ of 15 to 80 g/10 min, such as 20 to 70 g/10 min, most preferably 25 to 60 g/10 min.

The copolymer of the invention has a Flow Rate Ratio (FRR) of the MFR₂₁/MFR₂ in the range 22 to 100. Preferably the Flow Rate Ratio (FRR) of the MFR₂₁/MFR₂ is at least 24.0, more preferably at least 25.0 Furthermore, the polymer of the invention preferably has a Flow Rate Ratio (FRR) of the MFR₂₁/MFR₂ of up to 70.0, like up to 55.0, more preferably up to 40.0. Thus, a preferable range for the ratio of the MFR₂₁ (190° C., 21.6 kg, ISO 1133) to MFR₂ (190° C., 2.16 kg, ISO 1133), is 22 to 70, more preferably from 24 to 55, even more preferably 25 to 40

The density of the copolymer is in the range 910 to 930 kg/m³ determined according to ISO 1183. The copolymers of the invention are therefore typically considered linear low density polyethylenes (LLDPEs). Preferably, the polymer has a density of 911 to 928 kg/m³, more preferably 912 to 925 kg/m³, such as 913 to 922 kg/m³.

Furthermore, the copolymer of the invention is characterised by an isolated 1-butene comonomer unit amount (EBE %) of greater than 97.0%, whereby the isolated 1-butene comonomer unit amount is calculated according to formula (I)

$$EBE \% = 100 \times \frac{E B E}{E B E + E B B + B B B}$$

wherein EBE represents amount of comonomer sequence of ethylene, 1-butene and ethylene per 1000 carbon (kCb), EBB represents amount of comonomer sequence of ethylene, 1-butene and 1-butene per 1000 carbon (kCb) and BBB represents amount of comonomer sequence of three consecutive 1-butenes per 1000 carbon (kCb);

Preferable ranges for EBE % are 97.5 to 100%, such as 98.0 to 100%, for example 98.5 to 100%.

The copolymer of the invention is multimodal and thus comprises at least a lower molecular weight component (A) and a higher molecular weight component (B). In one particularly preferable embodiment, the copolymer consists of components (A) and (B). The weight ratio of component (A) to component (B) in the composition is in the range 30:70 to 70:30, more preferably 35:65 to 65:35, most preferably 40:60 to 60:40. In some embodiments the ratio may be 35 to 50 wt % of component (A) and 50 to 65 wt % component (B), such as 40 to 50 wt % of component (A) and 50 to 60 wt % component (B), wherein the wt % values are relative to the total weight of the multimodal polyethylene copolymer.

In a particularly preferred embodiment, the wt % values for components (A) and (B) add up to 100%.

Each of component (A) and component (B) is an ethylene copolymer. The term “ethylene copolymer” is defined above.

The lower molecular weight component (A) typically has an MFR₂ (190° C., 2.16 kg, ISO 1133) of 2.0 to 300 g/10 min, preferably of 2.0 to 200 g/10 min, more preferably of 2.8 to 150 g/10 min, even more preferably 3.0 to 100 g/10 min, such as 3.2 to 40 g/10 min.

Component (A) generally has a density of 915 to 975 kg/m³, preferably 920 to 960 kg/m³, more preferably 930 to 950 kg/m³, such as 933 to 942 kg/m³.

Component (A) is an ethylene-1-butene copolymer.

The higher molecular weight component (B) typically has an MFR₂ of 0.001 to 1.5 g/10 min, preferably of 0.01 to 1.5 g/10 min, more preferably of 0.05 to 1.5 g/10 min, even more preferably 0.1 to 1.2 g/10 min, such as 0.2 to 1.0 g/10 min.

Component (B) generally has a density of 880 to 910 kg/m³, preferably 885 to 905 kg/m³, such as 890 to 900 kg/m³.

Component (B) is an ethylene-1-butene copolymer.

In a particularly preferred embodiment, the copolymer of the invention comprises, preferably consists of:
(i) 30.0 to 70.0 wt % of an ethylene-1-butene polymer component (A), and
(ii) 70.0 to 30.0 wt % of an ethylene-1-butene polymer component (B).
   The amount of (A) and (B) preferably add up to 100.0 wt %.

In one embodiment of the present invention, the ethylene-1-butene polymer component (A) consists of an ethylene polymer fraction (A-1) and an ethylene polymer fraction (A-2). In case that the ethylene-1-butene polymer component (A) consists of ethylene polymer fractions (A-1) and (A-2), the MFR₂ of the ethylene polymer fractions (A-1) and (A-2) may be different from each other.

The ethylene polymer fraction (A-1) typically has a MFR₂ (190° C., 2.16 kg, ISO 1133) in the range of 1.0 to 300 g/10 min, preferably of 1.0 to 200 g/10 min, more preferably of 1.5 to 150 g/10 min, even more preferably of 2.0 to 100 g/10 min and especially preferably of 2.5 to 80 g/10 min, like 3.0 to 40 g/10 min.

The ethylene polymer fraction (A-2) may have a MFR₂ (190° C., 2.16 kg, ISO 1133) in the range of 1.0 to 300 g/10 min, preferably 3.0 to 40.0 g/10 min, more preferably of 3.2 to 30.0 g/10 min, even more preferably of 3.5 to 20.0 g/10 min and most preferably of 3.5 to 10.0 g/10 min.

The MFR₂ of the ethylene polymer components (A) and (B) are different from each other.

The ethylene polymer component (A) preferably has a MFR₂ (190° C., 2.16 kg, ISO 1133) in the range of 2.0 to 300 g/10 min, preferably of 2.0 to 200 g/10 min, more preferably of 2.8 to 150 g/10 min, even more preferably of 3.0 to 100 g/10 min, such as 3.2 to 40 g/10 min.

The ethylene polymer component (B) preferably has a MFR₂ (190° C., 2.16 kg, ISO 1133) in the range of 0.001 to 1.5 g/10 min, preferably 0.01 to 1.5 g/10 min, more preferably of 0.05 to 1.5 g/10 min, even more preferably of 0.1 to 1.2 g/10 min, such as 0.2 to 1.0 g/10 min.

In one embodiment of the invention it is preferred that the ratio of the MFR₂ (190° C., 2.16 kg, ISO 1133) of ethylene-1-butene polymer component (A) to the MFR₂ (190° C., 2.16 kg, ISO 1133) of the final multimodal copolymer is at least 2.5 to 300, preferably 3.0 to 150 and more preferably of 3.5 to 100.

Naturally, in addition to multimodality with respect to, i.e. the difference between, the MFR₂ of ethylene polymer components (A) and (B), the multimodal PE of the invention can also be multimodal e.g. with respect to one or both of the two further properties:

multimodality with respect to, i.e. difference between,
the comonomer content(s) present in the ethylene polymer components (A) and (B); and/or
the density of the ethylene polymer components (A) and (B).

Preferably, the multimodal copolymer is further multimodal with respect to the comonomer content of the ethylene polymer components (A) and (B).

The comonomer content of component (A) and (B) can be measured, or, in case, and preferably, one of the components is produced first and the other thereafter in the presence of the first produced in so called multistage process, then the comonomer content of the first produced component, e.g. component (A), can be measured and the comonomer content of the other component, e.g. component (B), can be calculated according to following formula:

Comonomer content (wt %) in component B=(comonomer content (wt %) in final product−(weight fraction of component A*comonomer content (wt %) in component A))/(weight fraction of component B)

Even more preferably the multimodal copolymer of the invention is further multimodal with respect to difference in density between the ethylene copolymer component (A) and ethylene copolymer component (B). Preferably, the density of ethylene copolymer component (A) is different, preferably higher, than the density of the ethylene copolymer component (B).

The density of the ethylene copolymer component (A) is generally in the range of 915 to 975 kg/m³, preferably of 920 to 960 kg/m³, more preferably 930 to 950 kg/m³, such as 933 to 942 kg/m³ and/or the density of the ethylene polymer component (B) is of in the range of 880 to 910 kg/m³, preferably of 885 to 905 kg/m³ and more preferably of 890 to 900 kg/m³.

The polymer fraction (A-1) typically has a density in the range of from 915 to 975 kg/m³, preferably of 925 to 955 kg/m³, more preferably of 930 to 950 kg/m³, like 935 to 945 kg/m³.

The density of the polymer fraction (A-2) is preferably in the range of from 915 to 975 kg/m³, more preferably of 935 to 945 kg/m³.

It is within the scope of the invention, that the first and the second ethylene polymer fraction (A-1 and A-2) of the ethylene polymer component (A) may be present in a weight ratio of 4:1 up to 1:4, such as 3:1 to 1:3, or 2:1 to 1:2, or 1:1.

The ethylene polymer component (A) is present in an amount of 30.0 to 70.0 wt % based on the multimodal copolymer, preferably in an amount of 32.0 to 55.0 wt % and even more preferably in an amount of 34.0 to 45.0 wt %.

Thus, the ethylene polymer component (B) is present in an amount of 70.0 to 30.0 wt % based on the multimodal copolymer, preferably in an amount of 68.0 to 45.0 wt % and more preferably in an amount of 66.0 to 55.0 wt %.

### Preparation of the Multimodal Ethylene Copolymer

The metallocene catalysed multimodal copolymer can be produced in a 2-stage process, preferably comprising a slurry reactor (loop reactor), whereby the slurry (loop) reactor is connected in series to a gas phase reactor (GPR), whereby the low molecular weight polymer component is produced in the loop reactor and the high molecular weight polymer component is produced in GPR in the presence of the low molecular weight polymer component to produce the multimodal copolymer.

In case that the ethylene component (A) of the multimodal copolymer consists of ethylene polymer fractions (A-1) and (A-2), the multimodal copolymer can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR), so that the first ethylene copolymer component (A) leaving the second slurry reactor is fed to the GPR to produce the polyethylene copolymer.

Such a process is described inter alia in WO 2016/198273, WO 2021009189, WO 2021009190, WO 2021009191 and WO 2021009192. Full details of how to prepare suitable metallocene catalysed multimodal copolymer can be found in these references.

A suitable process is the Borstar PE process or the Borstar PE 3G process.

The metallocene catalysed multimodal copolymer according to the present invention is therefore preferably produced in a loop loop gas cascade. Such polymerisation steps may be preceded by a prepolymerisation step. The purpose of the prepolymerisation is to polymerise a small amount of polymer onto the catalyst at a low temperature and/or a low monomer concentration. By prepolymerisation it is possible to improve the performance of the catalyst in slurry and/or modify the properties of the final polymer. The prepolymerisation step is preferably conducted in slurry and the amount of polymer produced in an optional prepolymerisation step is counted to the amount (wt %) of ethylene polymer component (A).

The catalyst components are preferably all introduced to the prepolymerisation step when a prepolymerisation step is present. However, where the solid catalyst component and the cocatalyst can be fed separately it is possible that only a part of the cocatalyst is introduced into the prepolymerisation stage and the remaining part into subsequent polymerisation stages. Also in such cases it is necessary to introduce so much cocatalyst into the prepolymerisation stage that a sufficient polymerisation reaction is obtained therein.

It is understood within the scope of the invention, that the amount or polymer produced in the prepolymerisation lies within 1 to 5 wt % in respect to the final metallocene catalysed multimodal copolymer. This can be counted as part of the first ethylene 1-butene copolymer component (A).

### Catalyst

The metallocene catalysed multimodal copolymer of the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In a preferred embodiment, the organometallic compound (C) is a bridged metallocene complex, i.e. one comprising a bridging ligand between the metallocene ligands.

In a further preferred embodiment, the organometallic compound (C) has the following formula (II):

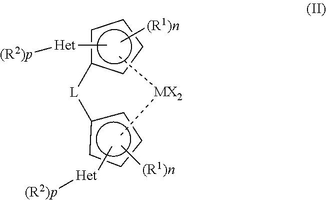

wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

Preferably, the compound of formula (II) has the structure

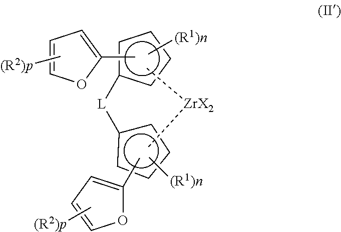

wherein each X is independently a halogen atom, a C₁₋₆-alkyl group, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (II) are

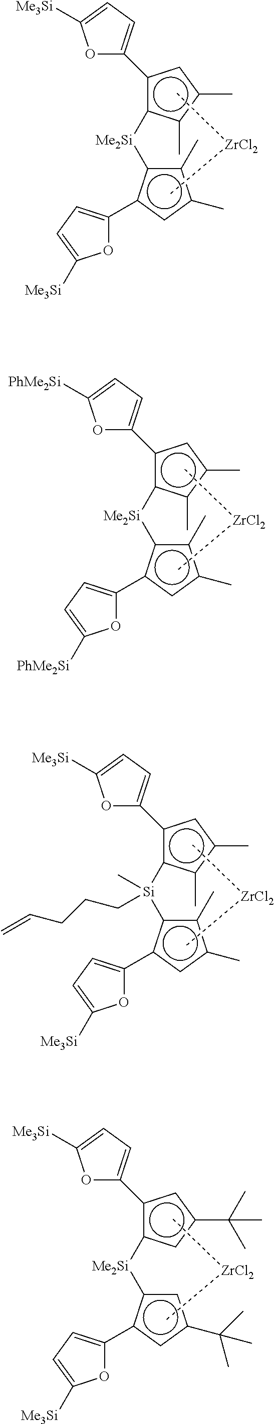

Most preferably the complex dimethylsilanediylbis[2-(5-trimethylsilylfuran-2-yl)-4,5-dimethylcyclopentadien-1-yl] zirconium dichloride is used.

It is particularly preferred if the metallocene catalyst contains only a single metallocene complex, and further preferred if that single metallocene complex is a bridged metallocene complex or a complex with a structure as defined above.

More preferably the high and low molecular weight components of the multimodal copolymer are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred.

Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

The metallocene catalysed multimodal ethylene-1-butene random copolymer may contain further polymer components and optionally additives and/or fillers. In case the metallocene catalysed multimodal copolymer contains further polymer components, then the amount of the further polymer component(s) typically varies between 3.0 to 20.0 wt % based on the combined amount of the metallocene catalysed multimodal copolymer and the other polymer component(s).

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

It is understood herein that any of the additives and/or fillers can optionally be added in so-called master batch, which comprises the respective additive(s) together with a carrier polymer. In such case the carrier polymer is not calculated to the polymer components of the metallocene catalysed multimodal copolymer, but to the amount of the respective additive(s), based on the total amount of polymer composition (100 wt %).

### Composition

The invention further relates to a polymer composition comprising the metallocene-catalysed multimodal ethylene-1-butene random copolymer as hereinbefore defined and 5 to 30 wt % of a low density polyethylene (LDPE), relative to the total weight of the composition.

The low density polyethylene, LDPE, is a polyethylene produced in a high pressure process. Typically, the polymerisation of ethylene and optional further comonomer(s) in a high pressure process is carried out in the presence of an initiator(s). The meaning of the term LDPE is well known and documented in the literature. The term LDPE describes and distinguishes a high pressure polyethylene from low pressure polyethylenes produced in the presence of an olefin polymerisation catalyst. LDPEs have certain typical features, such as different branching architecture. A typical density range for an LDPE is 0.910 to 0.940 g/cm³.

The low density polyethylene (LDPE) is an ethylene-based polymer. The term, “ethylene-based polymer,” as used herein, is a polymer that comprises a majority weight percent polymerised ethylene monomer (based on the total weight of polymerisable monomers), and optionally may comprise at least one polymerised comonomer. The ethylene-based polymer may include greater than 50, or greater than 60, or greater than 70, or greater than 80, or greater than 90 weight percent units derived from ethylene (based on the total weight of the ethylene-based polymer).

The LDPE may be a low density homopolymer of ethylene (referred herein as LDPE homopolymer) or a low density copolymer of ethylene with one or more comonomer(s) (referred herein as LDPE copolymer). The one or more comonomers of the LDPE copolymer are preferably selected from the polar comonomer(s), non-polar comonomer(s) or from a mixture of the polar comonomer(s) and non-polar comonomer(s). Moreover, said LDPE homopolymer or LDPE copolymer may optionally be unsaturated.

If the LDPE is a copolymer, it preferably comprises less than 10 wt %, more preferably less than 7 wt %, even more preferably less than 5 wt %, such as less than 3 wt % comonomer, relative to the total weight of the copolymer.

Preferably, the LDPE is a homopolymer.

The LDPE used in the composition of the invention may have a density of 915 to 940 kg/m³, preferably 918 to 935 kg/m³, especially 920 to 932 kg/m³, such as about 922 to 930 kg/m³.

The MFR₂ (2.16 kg, 190° C.) of the LDPE polymer is preferably from 0.05 to 30.0 g/10 min, more preferably is from 0.1 to 20 g/10 min, and most preferably is from 0.1 to 10 g/10 min, especially 0.1 to 5.0 g/10 min. In a preferred embodiment, the MFR₂ of the LDPE is 0.1 to 4.0 g/10 min, especially 0.3 to 4.0 g/10 min, especially 0.5 to 3.0 g/10 min.

The LDPE polymer is produced at high pressure by free radical initiated polymerisation (referred to as high pressure (HP) radical polymerisation). The HP reactor can be e.g. a well-known tubular or autoclave reactor or a mixture thereof, preferably a tubular reactor. The high pressure (HP) polymerisation and the adjustment of process conditions for further tailoring the other properties of the polyolefin depending on the desired end application are well known and described in the literature, and can readily be used by a skilled person. Suitable polymerisation temperatures range up to 400° C., preferably from 80 to 350° C. and pressure from 70 MPa, preferably 100 to 400 MPa, more preferably from 100 to 350 MPa. Pressure can be measured at least after compression stage and/or after the tubular reactor. Temperature can be measured at several points during all steps.

After the separation the obtained LDPE is typically in a form of a polymer melt which is normally mixed and pelletized in a pelletising section, such as pelletising extruder, arranged in connection to the HP reactor system. Optionally, additive(s), such as antioxidant(s), can be added in this mixer in a known manner. Further details of the production of ethylene (co)polymers by high pressure radical polymerisation can be found i.a. in the Encyclopedia of Polymer Science and Engineering, Vol. 6 (1986), pp 383-410 and Encyclopedia of Materials: Science and Technology, 2001 Elsevier Science Ltd.: “Polyethylene: High-pressure, R. Klimesch, D. Littmann and F.-O. Mähling pp. 7181-7184.

The LDPE (i) is present in an amount of 5 to 30 wt %, preferably 6 to 25 wt %, more preferably 7 to 20 wt %, such as 8 to 15 wt % relative to the total weight of the composition as a whole.

### Film

The film of the invention comprises at least one layer comprising the metallocene catalysed multimodal ethylene-1-butene random copolymer. The film can be a monolayer film comprising the metallocene catalysed multimodal ethylene-1-butene random copolymer a multilayer film, wherein at least one layer comprises the metallocene catalysed multimodal ethylene-1-butene random copolymer.

The terms “monolayer film” and multilayer film” have well known meanings in the art. Accordingly, the films of the present invention may comprise a single layer (i.e. monolayer) or may be multilayered. Multilayer films typically, and preferably, comprise at least 3 layers.

The layer of the monolayer or multilayer film of the invention may consist of the metallocene catalysed multimodal ethylene-1-butene random copolymer as such or of a blend of the metallocene catalysed multimodal ethylene-1-butene random copolymer together with further polymer(s). In case of blends, any further polymer is different from the metallocene catalysed multimodal ethylene-1-butene random copolymer and is preferably a polyolefin. Part of the above mentioned additives, like processing aids, can optionally added to the metallocene catalysed multimodal ethylene-1-butene random copolymer during the film preparation process.

Preferably, the at least one layer of the film of the invention comprises at least 50 wt %, more preferably at least 60 wt %, even more preferably at least 70 wt %, yet more preferably at least 80 wt %, of the metallocene catalysed multimodal ethylene-1-butene random copolymer of the invention. Most preferably said at least one layer of the film of invention consists of the metallocene catalysed multimodal ethylene-1-butene random copolymer.

The films are preferably produced by any conventional film extrusion procedure known in the art including cast film and blown film extrusion. Most preferably, the film is a blown or cast film, especially a blown film. E.g. the blown film is produced by extrusion through an annular die and blowing into a tubular film by forming a bubble which is collapsed between nip rollers after solidification. This film can then be slit, cut or converted (e.g. gusseted) as desired. Conventional film production techniques may be used in this regard. If the preferable blown or cast film is a multilayer film then the various layers are typically coextruded. The skilled man will be aware of suitable extrusion conditions.

Films according to the present invention may be subjected to post-treatment processes, e.g. surface modifications, lamination or orientation processes or the like. Such orientation processes can be mono-axially (MDO) or bi-axially orientation, wherein mono-axial orientation is preferred.

In another embodiment, the films are unoriented.

The resulting films may have any thickness conventional in the art. The thickness of the film is not critical and depends on the end use. Thus, films may have a thickness of, for example, 300 μm or less, typically 6 to 200 μm, preferably 10 to 180 μm, e.g. 20 to 150 μm or 20 to 120 μm. If desired, the polymer of the invention enables thicknesses of less than 100 μm, e.g. less than 50 μm.

The films of the present invention show good optical properties in view of haze transparency when measured according to ASTM D1003. The haze is typically 20.0% or lower such as 18.0 or 16.0% or lower. The haze may be in the range of 2.0 to 20.0, preferably 5.0 to 18.0, more preferably 7.0 to 16.0. Preferably the measurements for haze are done 40 μm films.

Further, it is preferred that the film has a tensile modulus (TM) determined according to ISO 527-3 on 40 μm films in machine direction (MD) of 150 MPa to 1000 MPa, more preferably in the range of 155 to 750 MPa, still more preferably in the range of 160 to 500 MPa.

The film preferably has a seal initiation temperature (SIT) of less than 95° C., more preferably less than 91° C. Ideally, the SIT will be at least 80° C., preferably at least 85° C.

In an embodiment, the films comprising the metallocene catalysed multimodal ethylene-1-butene random copolymer are additionally characterized by a dart-drop impact strength (DDI) determined according to ISO 7765-1:1988/Method A on a 40 μm monolayer test blown film of at least 200 g to 1700 g, preferably 225 g to 1000 g and more preferably 250 g to more than 750 g.

The films of the present invention may contain usual polymer additives, such as slip agents, UV-stabilisers, pigments, antioxidants, nucleating agents and so on. These additives may be carried on a carrier polymer in the form of a masterbatch.

For the avoidance of doubt, it is envisaged that usual polymer additives, e.g. as described above may be present even when each film layer “consists” of a particular polymer as defined above. The term “consists of” is not intended therefore to exclude the presence of polymer additives. It does however exclude the presence of other polymer components for blending. If a carrier polymer is used as part of a masterbatch, that is not excluded however. Articles may be free of any other mixing polymers but may still comprise minor amounts of carrier polymer used for masterbatches.

The films of the invention have a wide variety of applications but are of particular interest in packaging. Thus, viewed from another aspect, the invention provides an article, preferably a packaging article, comprising a film as hereinbefore defined.

The present invention will now be described in further detail by the examples provided below:

The following definitions of terms and determination methods apply for the above general description of the invention as well as to the below examples unless otherwise defined.

### Determination Methods

### Isolated 1-butene Comonomer Unit Amount (EBE %)

The isolated 1-butene comonomer unit amount (EBE %) is calculated according to formula (I)

$$EBE \% = 100 \times \frac{EBE}{EBE + EBB + BBB}$$

wherein EBE represents amount of comonomer sequence of ethylene, 1-butene and ethylene per 1000 carbon (kCb), EBB represents amount of comonomer sequence of ethylene, 1-butene and 1-butene per 1000 carbon (kCb) and BBB represents amount of comonomer sequence of three consecutive 1-butenes per 1000 carbon (kCb).

### Melt Flow Rate (MFR)

The melt flow rates are measured at 190° C. with a load of 2.16 kg (MFR₂) or 5.0 kg (MFR₅) or 21.6 kg (MFR₂₁) according to ISO 1133.

### Calculation of MFR₂ of Fractions (A) and (B)

$$log A = x \cdot log B + ( 1 - x ) \cdot log C$$

$$C = 10 \hat{} \frac{( log A - x \cdot log B )}{( 1 - x )}$$

B=MFR₂ of Fraction (A)
C=MFR₂ of Fraction (B)
A=final MFR₂ (mixture) of multimodal polyethylene copolymer (P)
X=weight fraction of Fraction (A)

### Flow Rate Ratio (FRR21/2))

FRR is determined as the ratio between the MFR₂₁ and the MFR₂.

### GPC

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{z} = \frac{{\sum }_{i = 1}^{N} ( {A}_{i} \times {M}_{i}^{2} )}{{\sum }_{i = 1}^{N} ( {A}_{i} \times {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain), equipped with 3× Agilent-PLgel Olexis and 1× Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration (according to ISO 16014-2:2003) with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

$${K}_{PS} = 19 \times {10}^{- 3} mL / g , {α}_{PS} = 0 \text{.655}$$

$${K}_{PE} = 39 \times {10}^{- 3} mL / g , {α}_{PE} = 0.7 \; 25$$

$${K}_{PP} = 19 \times {10}^{- 3} mL / g , {α}_{PP} = 0.725$$

A third order polynomial fit was used to fit the calibration data.

All samples were prepared in the concentration range of 0.5-1 mg/ml and dissolved at 160° C. for 2.5 hours for PP or 3 hours for PE under continuous gentle shaking.

### Comonomer Contents

### Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Avance III 500 NMR spectrometer operating at 500.13 and 125.76 MHz for ¹H and ¹³C respectively. All spectra were recorded using a ¹³C optimised 7 mm magic-angle spinning (MAS) probehead at 150° C. using nitrogen gas for all pneumatics.

Approximately 200 mg of material was packed into a 7 mm outer diameter zirconia MAS rotor and spun at 4 kHz. This setup was chosen primarily for the high sensitivity needed for rapid identification and accurate quantification (Klimke, K., Parkinson, M., Piel, C., Kaminsky, W., Spiess, H. W., Wilhelm, M., Macromol. Chem. Phys. 2006; 207:382., Parkinson, M., Klimke, K., Spiess, H. W., Wilhelm, M., Macromol. Chem. Phys. 2007; 208:2128., Castignolles, P., Graf, R., Parkinson, M., Wilhelm, M., Gaborieau, M., Polymer 50 (2009) 2373). Standard single-pulse excitation was employed utilising the transient NOE at short recycle delays of 3 s (Pollard, M., Klimke, K., Graf, R., Spiess, H. W., Wilhelm, M., Sperber, O., Piel, C., Kaminsky, W., Macromolecules 2004; 37:813., Klimke, K., Parkinson, M., Piel, C., Kaminsky, W., Spiess, H. W., Wilhelm, M., Macromol. Chem. Phys. 2006; 207:382.) and the RS-HEPT decoupling scheme (Filip, X., Tripon, C., Filip, C., J. Mag. Resn. 2005, 176, 239, Griffin, J. M., Tripon, C., Samoson, A., Filip, C., and Brown, S. P., Mag. Res. in Chem. 2007 45, S1, S198). A total of 1024 (1 k) transients were acquired per spectrum.

Quantitative ¹³C{¹H} NMR spectra were processed, integrated and quantitative properties determined using custom spectral analysis automation programs. All chemical shifts are internally referenced to the bulk methylene signal (δ+) at 30.00 ppm (J. Randall, Macromol. Sci., Rev. Macromol. Chem. Phys. 1989, C29, 201).

Characteristic signals corresponding to the incorporation of 1-butene were observed (J. Randall, Macromol. Sci., Rev. Macromol. Chem. Phys. 1989, C29, 201.) and all contents calculated with respect to all other monomers present in the polymer.

Characteristic signals resulting from isolated 1-butene incorporation i.e. EEBEE comonomer sequences, were observed. Isolated 1-butene incorporation was quantified using the integral of the signal at 39.8 ppm assigned to the *B2 sites, accounting for the number of reporting sites per comonomer:

$$B = {I}_{* B 2}$$

When characteristic signals resulting from consecutive 1-butene incorporation i.e. EBBE comonomer sequences were observed, such consecutive 1-butene incorporation was quantified using the integral of the signal at 39.3 ppm assigned to the ααB2B2 sites accounting for the number of reporting sites per comonomer:

$$BB = 2 * {I}_{α α B 2 B 2}$$

When characteristic signals resulting from non consecutive 1-butene incorporation i.e. EBEBE comonomer sequences were also observed, such non-consecutive 1-butene incorporation was quantified using the integral of the signal at 24.7 ppm assigned to the ββB2B2 sites accounting for the number of reporting sites per comonomer:

$$BEB = 2 * {I}_{β β B 2 B 2}$$

Due to the overlap of the *B2 and *βB2B2 sites of isolated (EEBEE) and non-consecutively incorporated (EBEBE) 1-butene respectively the total amount of isolated 1-butene incorporation is corrected based on the amount of non-consecutive 1-butene present:

$$B = {I}_{* B 2} - 2 * {I}_{β β B 2 B 2}$$

With no other signals indicative of other comonomer sequences, i.e. 1-butene chain initiation, observed the total 1-butene comonomer content was calculated based solely on the amount of isolated (EEBEE), consecutive (EBBE) and non-consecutive (EBEBE) 1-butene comonomer sequences:

Bₜₒₜₐₗ=B+BB+BEB

Characteristic signals resulting from saturated end-groups were observed. The content of such saturated end-groups was quantified using the average of the integral of the signals at 22.8 and 32.2 ppm assigned to the 2 s and 3 s sites respectively:

$$S = ( 1 / 2 ) * ( {I}_{2 S} + {I}_{3 S} )$$

The relative content of ethylene was quantified using the integral of the bulk methylene (δ+) signals at 30.00 ppm:

$$E = ( 1 / 2 ) * {I}_{δ +}$$

The total ethylene comonomer content was calculated based the bulk methylene signals and accounting for ethylene units present in other observed comonomer sequences or end-groups:

$${E}_{total} = E + ( 5 / 2 ) * B + ( 7 / 2 ) * BB + ( 9 / 2 ) * BEB + ( 3 / 2 ) * S$$

The total mole fraction of 1-butene in the polymer was then calculated as:

$$fB = {B}_{total} / ( {E}_{total} + {B}_{total} )$$

The total comonomer incorporation of 1-butene in mole percent was calculated from the mole fraction in the usual manner:

$$B [ mol \% ] = 100 * fB$$

The total comonomer incorporation of 1-butene in weight percent was calculated from the mole fraction in the standard manner:

$$B [ wt \% ] = 100 * ( fB * 56.11 ) / ( ( fB * 56.11 ) + ( ( 1 - fB ) * 28. 05 ) )$$

### Density

The density was measured according to ISO 1183 and ISO1872-2 for sample preparation.

### Tensile Modulus, Tensile Strength & Elongation

Tensile modulus, tensile strength and elongation were measured in machine and/or transverse direction according to ISO 527-3 on film samples prepared as described under the Film Sample preparation with film thickness of 40 μm and at a cross head speed of 1 mm/min for the modulus.

### Haze

Haze as a measure for the optical appearance of the films was determined according to ASTM D1003 on film samples with a thickness of 40 μm.

### Dart Drop Strength (DDI): Impact Resistance by Free-Falling Dart Method

The DDI was measured according to ISO 7765-1:1988/Method A from the films as produced indicated below. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions:

Conditioning time: >96 h
Test temperature: 23° C.
Dart head material: phenolic
Dart diameter: 38 mm
Drop height: 660 mm

### Seal Initiation Temperature

The method determines the sealing temperature range (sealing range) of polyethylene films, in particular blown films or cast films. The sealing temperature range is the temperature range, in which the films can be sealed according to conditions given below.

The lower limit (heat sealing initiation temperature (SIT)) is the sealing temperature at which a sealing strength of 5 N is achieved. The upper limit (sealing end temperature (SET)) is reached, when the films stick to the sealing device.

The measurement was done according to the slightly modified ASTM F1921-12, where the test parameters sealing pressure, cooling time and test speed have been modified. The determination of the force/temperature curve was continued until thermal failure of the film.

The sealing range was determined on a J&B Universal Sealing Machine Type 4000 with the films as produced indicated below blown film of 40 μm thickness with the following further parameters:
Conditioning time: >96 h
Specimen width: 25 mm
Sealing pressure: 0.4 N/mm² (PE)
Sealing time: 1 sec
Delay time: 30 sec
Sealing jaws dimension: 50×5 mm
Sealing jaws shape: flat
Sealing jaws coating: Niptef
Sealing temperature: ambient −240° C.
Sealing temperature interval: 5° C.
Start temperature: 50° C.
Grip separation rate: 42 mm/sec

### EXAMPLES

### Materials

LLDPE1: a m-LLDPE with MFR₂ 1.23 g/10 min, density 914.3 kg/m³, it is produced using the polymerisation parameters in Table 1.
LLDPE2: a mLLDPE with MFR₂ 1.0 g/10 min, density 915.3 kg/m³, it is produced using the polymerisation parameters in Table 1.
LLDPE3: is a mLLDPE with MFR₂ 1.93 g/10 min, density 918 kg/m³, it is produced using the polymerisation parameters in Table 1.

The catalyst used in the production of LLDPE1 and LLDPE2 (Cat1) comprises the metallocene complex dimethylsilanediylbis[2-(5-trimethylsilylfuran-2-yl)-4,5-dimethylcyclopentadien-1-yl] zirconium dichloride.

### Preparation of Cat1

### Loading of SiO2:

10 kg of silica (PQ Corporation ES757, calcined 600° C.) was added from a feeding drum and inertized in the reactor until O₂ level below 2 ppm was reached.

### Preparation of MAO/tol/MC:

30 wt % MAO in toluene (14.1 kg) was added into another reactor from a balance followed by toluene (4.0 kg) at 25° C. (oil circulation temp) and stirring 95 rpm.

Stirring speed was increased 95 rpm->200 rpm after toluene addition, stirring time 30 min. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring was turned to 40 rpm during MAO/tol/MC addition. MAO/tol/MC solution (22.2 kg) was added within 205 min followed by 60 min stirring time (oil circulation temp was set to 25° C.).

After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

The catalyst used in the production of LLDPE3 (Cat2) comprises the metallocene complex bis(1-methyl-3-n-butylcyclopentadienyl) zirconium (IV) dichloride.

It is disclosed in WO2022/018290 as CE1-1
LLDPE4: is FG5190, commercially available from Borealis, it is a zn-LLDPE with MFR₂ 1.2 g/10 min, density 919 kg/m³
LDPE: FT5230, a LDPE commercially available from Borealis with density 923 kg/m³ and MFR₂ 0.75 g/10 min

Table 1 shows the typical polymerisation parameters and final polymer properties for LLDPE1, LLDPE2 and LLDPE3.

TABLE 1

| | LLDPE1 | LLDPE2 | LLDPE3 |
|---|---|---|---|
| catalyst | Cat1 | Cat1 | Cat2 |
| catalyst amount/feed ratio | 34 g/h | 32 g/h | 27 g/h |
| A1 Prepoly reactor | | | |
| Temp. (° C.) | 50 | 50 | 50 |
| Press. (kPa) | 5707 | 5692 | 5737 |
| C2 (kg/h) | 4.0 | 4.0 | |
| H2 (g/h) | 0.04 | 0.04 | 0.2 |
| C4 (g/h) | 68.8 | 68.8 | 100.0 |
| Split (%) | 3.6 | 3.6 | 2.7 |
| A21 loop reactor | | | |
| Temp. (° C.) | 85 | 85 | 85 |
| Press. (kPa) | 5450 | 5452 | 5553 |
| C2 conc. (mol-%) | 2.6 | 2.9 | 2.4 |
| H2/C2 ratio (mol/kmol) | 0.49 | 0.52 | 0.09 |
| C4/C2 ratio (mol/kmol) | 53.9 | 51.9 | 69.3 |
| Split % | 18.5 | 18.3 | 19.0 |
| Density (kg/m³) | 936.6 | 934.9 | 940.5 |
| MFR₂ (g/10 min) | 4.8 | 5.7 | 4.3 |
| A2 loop reactor | | | |
| Temp. (° C.) | 85 | 85 | 85 |
| Press. (kPa) | 5265 | 5268 | 5369 |
| C2 conc. (mol-%) | 3.1 | 3.4 | 2.1 |
| H2/C2 ratio (mol/kmol) | 0.4 | 0.4 | 0.1 |
| C4/C2 ratio (mol/kmol) | 52 | 54 | 128 |
| Split (%) | 21.1 | 21.0 | 19.0 |
| Density (kg/m³) | 936.1 | 935.7 | 940.0 |
| MFR₂ (g/10 min) | 6.1 | 7.2 | 6.4 |
| Density in loop 2(kg/m³) | 935.6 | 936.5 | 939.4 |
| MFR₂ in loop 2 | 7.8 | 9.2 | 10.0 |
| (g/10 min) | | | |
| A3 GPR | | | |
| Temp. (° C.) | 75 | 75 | 75 |
| H2/C2 ratio (mol/kmol) | 1.21 | 1.00 | 0.23 |
| C4/C2 ratio (mol/kmol) | 61.79 | 56.21 | 125.30 |
| Split % | 56.8 | 57.1 | 59.3 |
| MFR₂ (GPR) (g/10 min) | 0.4 | 0.2 | 0.8 |
| Density (GPR) (kg/m³) | 897.7 | 900.0 | 905.6 |
| Pellet | | | |
| MFR₂ (g/10 min) | 1.23 | 1.0 | 1.93 |
| MFR₂₁ (g/10 min) | 34.00 | 29.10 | 39.90 |
| Density (kg/m³) | 914.3 | 915.3 | 918.4 |

The polymers were mixed with 2400 ppm of Irganox B561. 270 ppm of Dynamar FX 5922 compounded and extruded under nitrogen atmosphere to pellets by using a JSW extruder so that the SEI was 230 kWh/kg and the melt temperature 250° C. to form pellets. Final properties are summarised below in Table 2.

TABLE 2

| | | IE1 | IE2 | CE1 | CE2 |
|---|---|---|---|---|---|
| | | LLDPE1 | LLDPE2 | LLDPE3 | LLDPE4 |
| MFR₂ | g/10 min | 1.23 | 1.0 | 1.93 | 1.2 |
| MFR₂₁ | g/10 min | 34.00 | 29.10 | 39.90 | 36.9 |
| MFR₂₁/MFR₂ | | 27.6 | 28.5 | 20.7 | 30.8 |
| Density | kg/m³ | 914.3 | 915.3 | 918 | 919 |
| C4 | mol % | 4.7 | 4.4 | 3.9 | 3.9 |
| C4 | wt % | 9.98 | 8.43 | 7.50 | 7.50 |
| EBE | | 19.7 | 18.5 | 15.9 | 16 |
| EBB | | 0 | 0 | 0.5 | 0.5 |
| BBB | | 0 | 0 | 0 | 0 |
| EBE % | | 100.0 | 100.0 | 97.0 | 97.0 |

### Film Preparation

The film is produced on a Collin 30 lab scale line. the film thickness is 40 μm, blow up ratio 1:2.5, frostline distance 120 cm, melt temperature 210° C., output rate 7 kg/h. Blending of LLDPE with LDPE was done directly on blown film line.

TABLE 3

| Polymer | | IE1 | IE2 | CE1 | CE2 |
|---|---|---|---|---|---|
| TM/MD | MPa | 160 | 183 | 246 | 222 |
| TM/TD | MPa | 169 | 192 | n.m. | 271 |
| DDI | g | 278 | 413 | 188 | 108 |
| Haze | % | 10.2 | 15.7 | 38.93 | 15.05 |
| SIT | ° C. | 85 | 86 | 91 | n.m. |
| With 10% LD | | | | | |
| TM/MD | MPa | 168 | | 271 | |
| TM/TD | MPa | 190 | | n.m. | |
| DDI | g | 200 | | 167 | |
| Haze | % | 6.56 | | 6.98 | |
| SIT | ° C. | 90 | | 97 | |

1. A metallocene-catalyzed multimodal ethylene-1-butene random copolymer, having:
a density in the range of from 910 to 930 kg/m³ determined according to ISO 1183,
an MFR₂ determined according to ISO 1133 at 190° C. and 2.16 kg, in the range of from 0.1 to 3.0 g/10 min,
a 1-butene content in the range of 1.0 to 20 wt %,
an isolated 1-butene comonomer unit amount (EBE %) of greater than 97.0%,
whereby the isolated 1-butene comonomer unit amount is calculated according to formula (I)
$$EBE \% = 100 \times \frac{EBE}{EBE + EBB + BBB}$$
wherein
EBE represents amount of comonomer sequence of ethylene, 1-butene and ethylene per 1000 carbon (kCb),
EBB represents amount of comonomer sequence of ethylene, 1-butene and 1-butene per 1000 carbon (kCb) and
BBB represents amount of comonomer sequence of three consecutive 1-butenes per 1000 carbon (kCb) as described under “Determination methods”; and
a ratio of the MFR₂₁ determined according to ISO 1133 at 190° C. and 21.6 kg to MFR₂ determined according to ISO 1133 at 190° C. and 2.16 kg, MFR₂₁/MFR₂, in the range of 22 to 100.

2. The metallocene-catalyzed multimodal ethylene-1-butene random copolymer as claimed in claim 1, wherein said metallocene catalyst comprises a bridged metallocene complex.

3. The metallocene-catalyzed multimodal ethylene-1-butene random copolymer as claimed in claim 1, wherein the ratio of MFR₂₁/MFR₂ is in the range of from 22 to 70.

4. The metallocene-catalyzed multimodal ethylene-1-butene random copolymer as claimed in claim 1, wherein the total amount of 1-butene, based on the multimodal copolymer, is in the range of from 5.0 to 15 wt %.

5. The metallocene-catalyzed multimodal ethylene-1-butene random copolymer as claimed in claim 1, wherein said copolymer has an isolated 1-butene comonomer unit amount (EBE %) of 97.5 to 100%.

6. The metallocene-catalyzed multimodal ethylene-1-butene random copolymer as claimed in claim 1, wherein said copolymer comprises
(A) a lower molecular weight ethylene-1-butene copolymer component, and
(B) a higher molecular weight ethylene-1-butene copolymer component.

7. The metallocene-catalyzed multimodal ethylene-1-butene random copolymer as claimed in claim 6, wherein
the lower molecular weight ethylene-1-butene copolymer component (A) has a MFR₂ determined according to ISO 1133 at 190° C. and 2.16 kg of 2.0 to 300 g/10 min; and
the higher molecular weight ethylene-1-butene copolymer component (B) has a MFR₂ determined according to ISO 1133 at 190° C. and 2.16 kg of 0.001 to 1.5 g/10 min.

8. The metallocene-catalyzed multimodal ethylene-1-butene random copolymer as claimed in claim 6, wherein the lower molecular weight ethylene-1-butene copolymer component (A) is present in an amount of 30 to 70 wt % based on the total weight of the multimodal copolymer, and the higher molecular weight ethylene-1-butene copolymer component (B) is present in an amount of 70 to 30 wt % based on the total weight of the multimodal copolymer.

9. The metallocene-catalyzed multimodal ethylene-1-butene random copolymer as claimed in claim 6, wherein the lower molecular weight ethylene-1-butene copolymer component (A) consists of a first ethylene polymer fraction (A-1) and a second ethylene polymer fraction (A-2).

10. A process for preparing the metallocene-catalyzed multimodal ethylene-1-butene random copolymer as defined in claim 1, said process comprising:
(i) polymerizing ethylene together with 1-butene, in a first polymerization stage in the presence of a metallocene catalyst to prepare a first ethylene polymer;
(ii) polymerizing ethylene together with 1-butene, in a second polymerization stage in the presence of said metallocene catalyst and said first ethylene polymer to prepare an ethylene polymer mixture comprising said first ethylene polymer and a second ethylene polymer; and
(iii) polymerizing ethylene together with 1-butene, in a third polymerization stage in the presence of said metallocene catalyst and said ethylene polymer mixture to prepare said multimodal ethylene-1-butene random copolymer.

11. A composition comprising:
the metallocene-catalyzed multimodal ethylene-1-butene random copolymer as defined in claim 1, and
5 to 30 wt % of a low density polyethylene (LDPE), relative to the total weight of the composition.

12. A film comprising the metallocene-catalyzed multimodal ethylene-1-butene random copolymer as defined in claim 1.

13. The film as claimed in claim 12, wherein said film is characterized by a sealing initiation temperature determined as described in the experimental part on a blown film with a thickness of 40 μm of below 95° C.

14. The film according to claim 12, wherein the film is characterized by a dart-drop impact strength (DDI) determined according to ISO 7765-1:1988/Method A on a 40 μm monolayer test blown film of at least 200 g.

15. An article comprising the film as defined in claim 12.

16. The metallocene-catalyzed multimodal ethylene-1-butene random copolymer as claimed in claim 2, wherein said bridged metallocene complex has the following formula (II): 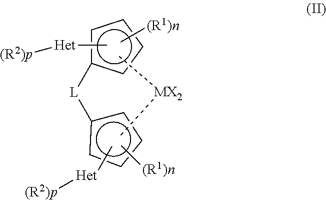
wherein
each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

17. The metallocene-catalyzed multimodal ethylene-1-butene random copolymer as claimed in claim 1, wherein the ratio of MFR₂₁/MFR₂ is in the range of from 24 to 55.

18. The metallocene-catalyzed multimodal ethylene-1-butene random copolymer as claimed in claim 1, wherein the ratio of MFR₂₁/MFR₂ is in the range of from 25 to 40.

19. The metallocene-catalyzed multimodal ethylene-1-butene random copolymer as claimed in claim 1, wherein the total amount of 1-butene, based on the multimodal copolymer, is in the range of from 8.0 to 10 wt %.

20. The metallocene-catalyzed multimodal ethylene-1-butene random copolymer as claimed in claim 7, wherein
the lower molecular weight ethylene-1-butene copolymer component (A) has a MFR₂ determined according to ISO 1133 at 190° C. and 2.16 kg of 3.2 to 40 g/10 min;
the higher molecular weight ethylene-1-butene copolymer component (B) has a MFR₂ determined according to ISO 1133 at 190° C. and 2.16 kg of 0.01 to 1.5 g/10 min; or
a combination thereof.
